(19) United States
(12) Patent Application Publication
(10) Pub. No.: US 2025/0001554 A1
(43) Pub. Date: Jan. 2, 2025

(54) CABLE PLIERS

(71) Applicants: Marvin Andrew Kuentzel, JR., Anchorage, AK (US); John Christopher Ludden, Fox Lake, IL (US)

(72) Inventors: Marvin Andrew Kuentzel, JR., Anchorage, AK (US); John Christopher Ludden, Fox Lake, IL (US)

(21) Appl. No.: 18/659,383

(22) Filed: May 9, 2024

Related U.S. Application Data
(60) Provisional application No. 63/501,607, filed on May 11, 2023.

(51) Int. Cl. B25B 7/08; B25B 7/02

(52) U.S. Cl. CPC B25B 7/08; B25B 7/02

(57) ABSTRACT

A simple unique tool designed to improve the technique, safety, limit damage, and create efficiencies to remove and/or replace spring-loaded electrical contacts in various connectors. The plier design utilizes a narrow upper jaw to easily fit between a contactor housing and the electrical contact. The lower jaw is cushioned with a protective element to not damage the housing. Effortlessly deployed, the cable plier depresses the spring, relieving tension on the contact for ease of contact removal. Unlike other removal methods and practices, the tool keeps the housing and springs intact.

### CROSS-REFERENCE TO RELATED APPLICATION

U.S. Provisional Application No. 63/501,607 filed May 11, 2023.

### BACKGROUND

Many power and other spring-loaded connectors and/or certain high power jumper cables (e.g., fork lift, truck jumper cables) of varying power ratings have one or more contacts placed within a housing. These power connectors typically have single-piece impact-resistant housings that can be made of materials like polycarbonate, for example. The electrical contacts are positioned and held within the housing, with an integrated spring, for protection during use and storage. These electrical contacts are usually solid copper contacts crimped onto wire. When the assembly or housing becomes worn, damaged, or breaks, the components need to be replaced.

Because the electrical contacts are held in place by an integrated spring and are embedded within the housing, removing them can be difficult. Typically, a person uses a screwdriver probe to both depress the spring and remove the contact from the housing. However, these users often break or crack the housing when trying to remove and/or replace an electrical contact. Sometimes, the housing shatters or cracks beyond further use and the entire connector must be replaced.

Therefore, the art would benefit from improved tools and/or techniques to remove and/or replace spring-loaded electrical contacts for various connectors.

### BRIEF SUMMARY OF THE INVENTION

Spring-loaded connectors typically utilize an integrated spring that is embedded within an impact-resistant housing. Utilizing current practices and techniques, contact housings often break or crack when trying to remove and/or replace the housed electrical contact. An improved method to depress the spring for contact removal is accomplished using a simple yet unique plier design that utilizes a narrow upper jaw that easily fits between the contactor housing and the electrical contact. The pliers lower jaw is cushioned preventing contact housing damage.

Effortlessly deployed and without causing damage, the various embodiments improve the technique, safety, and efficiency when removing or replacing spring-loaded electrical contacts from various connector housings.

### BRIEF DESCRIPTION OF THE DRAWINGS

Non-limiting and non-exhaustive embodiments of the invention are described with reference to the following drawings. In the drawings, like reference numerals refer to like parts throughout the various figures, unless otherwise specified, wherein:

FIGS. 1 through 3B show various views of the exemplary cable pliers illustrating the embodiments in accordance with this disclosure. The narrow tip jaw is referred to as “upper jaw” or “upper jaws” and the wide cushioned jaw as “lower jaw” or “lower jaws” in this disclosure.

FIG. 1 is a perspective view of the cable pliers and illustrates the unique jaw shapes;

FIG. 2A is a front view of the cable pliers, with the lower jaw in the foremost position;

FIG. 2B is the right side view of FIG. 2A, showing the narrow tip of the upper jaw foremost;

FIG. 2C is the reverse view of FIG. 2A;

FIG. 2D is the right side view of FIG. 2C, showing the wide cushioned lower jaw foremost;

FIG. 3A shows the cable pliers in an open position;

FIG. 3B is the reverse view of FIG. 3A;

FIGS. 4 through 5B show action views of the cable pliers in use.

FIG. 4 is a perspective view of the cable pliers inserted into a connector housing and depressing the connector spring;

FIG. 5A is a cutaway side view of the connector housing showing the cushioned lower jaws placed against the connector housing and the narrow tip of the upper jaws inserted into the housing;

FIG. 5B is a cutaway side view of the connector housing showing the pliers depressing the spring. The cable tip has been released from the spring and the cable partially withdrawn.

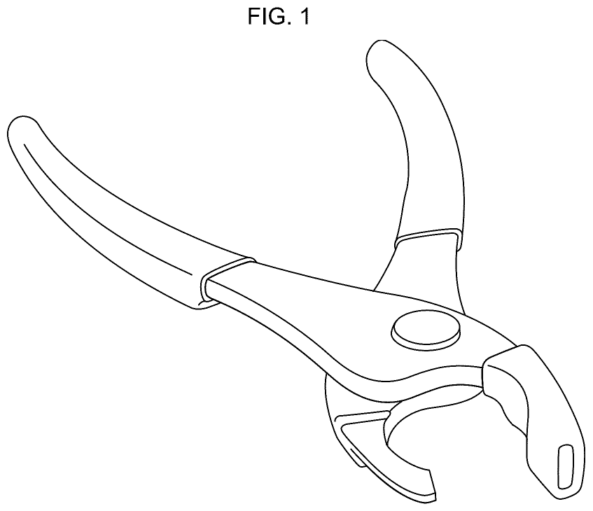

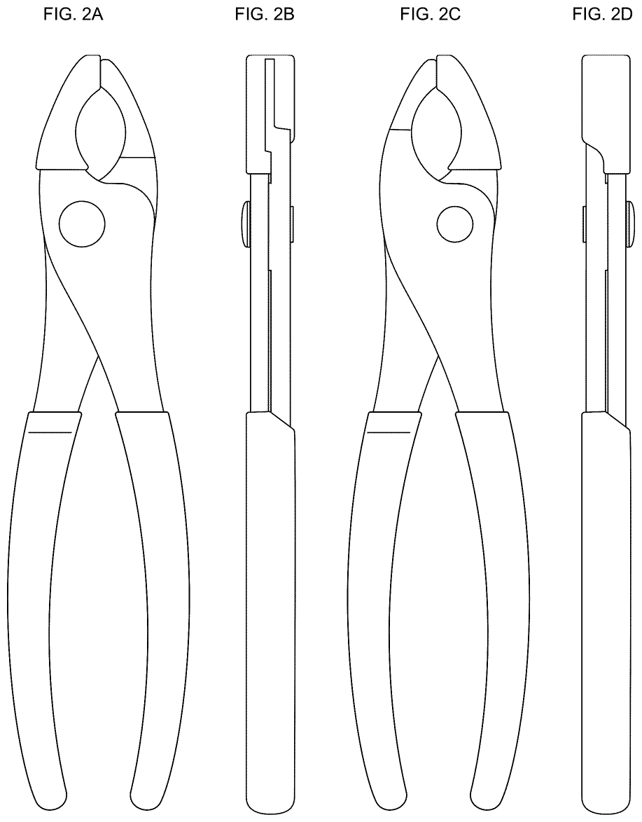

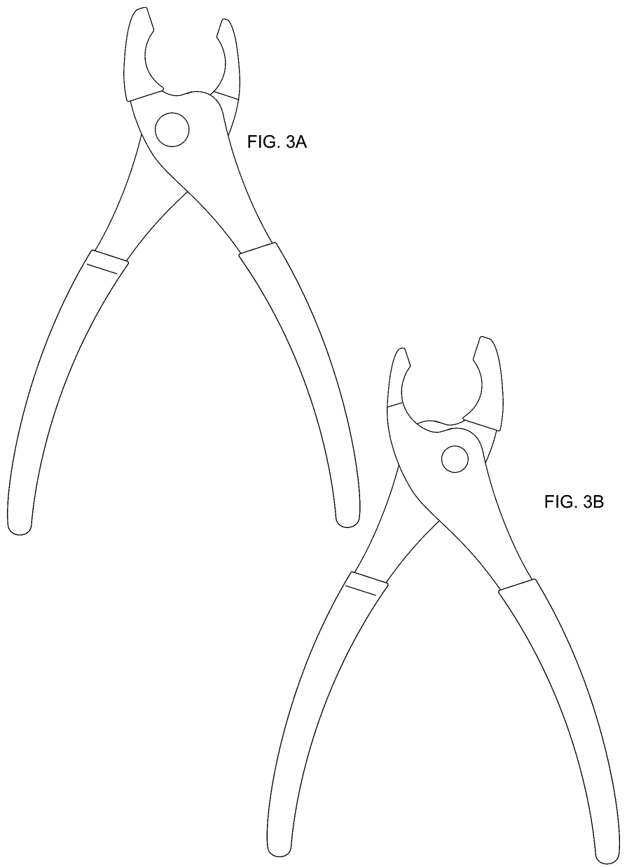

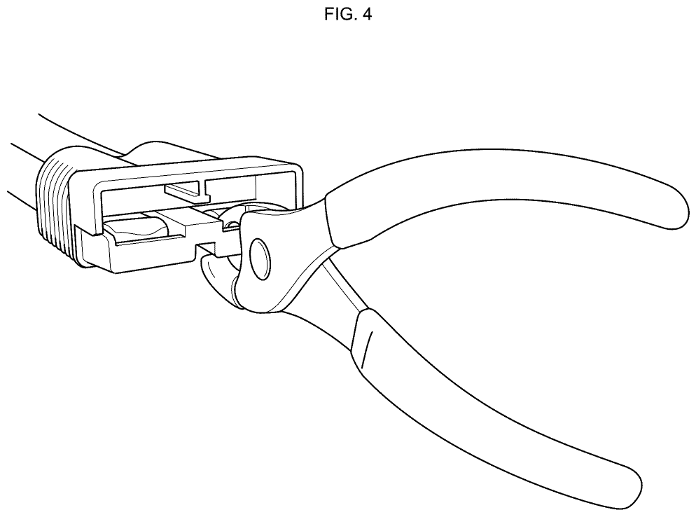

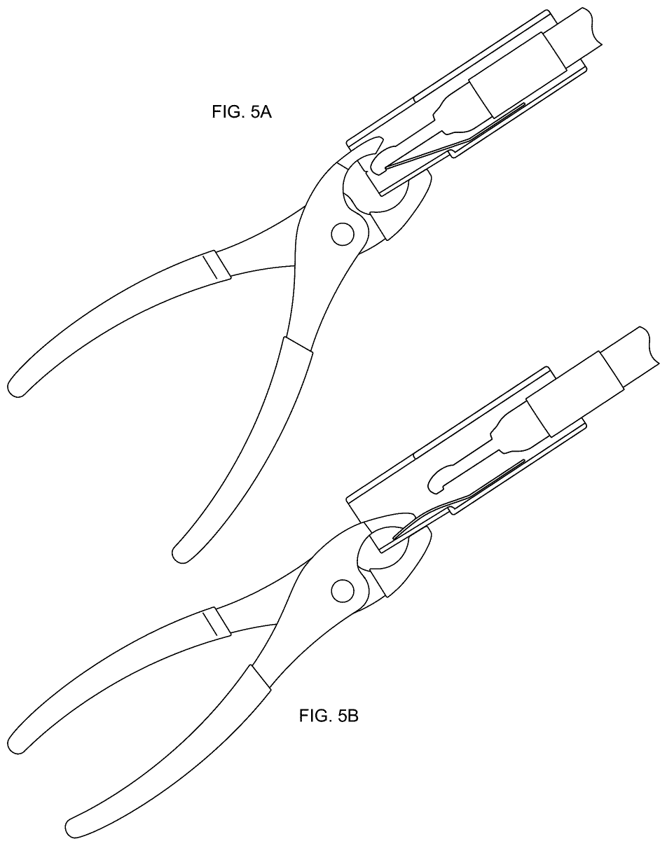

### DETAILED DESCRIPTION

The subject matter of embodiments disclosed herein is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

The disclosed pliers are used to load the spring deployed to retain the electrical connector within a housing and to disconnect or allow the electrical connector to be removed from the housing. The pliers are a handheld design and can be used in spring-loaded electrical connectors that are embedded or integrated within a housing. The pliers have two legs connected to a hinge or pivot point and two jaws also connected to the pivot point opposite the two legs. The jaws are designed to grip objects in a conventional manner. However, unlike conventional plier designs, the jaws have different widths. In an example, one of the jaws has a standard plier's width while the other jaw has a smaller/narrower width. For example, the narrow jaw could be 50% or less in width than the standard width jaw.

The lower jaws include a protective element, such as a protective coating, that extends over a portion or the entirety of the surface area of the lower jaws. The protective element provides a barrier between the lower jaws and the exterior surface of the housing of the connector. This barrier attenuates and/or distributes force over the surface of the housing to mitigate the risk of the jaws damaging the housing when they contact each other. One embodiment of the protective coating includes a heat shrink that covers a substantial portion of the lower jaws.

In an example, the lower jaws has a beveled tip with one or both of the tip portion of the jaws having a rounded edge. The rounded edge(s) of the lower jaws is placed on the exterior surface of the housing in which the electrical contact is positioned while the upper jaws is inserted into the opening that exposes the electrical contact. The lower jaws has the rounded or a beveled edge to delicately grip the exterior of the connector housing without as much condensed force in a single point of contact as a standard straight or flat edge jaws would apply to the housing.

The upper jaws has a width that is substantially smaller than the width of the lower jaws. This small width allows for the upper jaws to be inserted into the opening exposing the electrical contact to load the spring engaging the electrical contact without directly applying force to the electrical contact itself. The upper jaws can be positioned to one side or the other of the electrical contact to load the spring while the electrical contact is unloaded from the spring for an easy removal.

In some examples, the upper jaws has a tapered shape from its base to its tip or in gradually decreases its width from its base to its tip. In other examples, the upper jaws is uniform width. The upper jaws can have a tip that is pointed, rounded, squared, beveled or the like. In an example, the tip of the upper jaws is pointed to allow for it to be inserted beneath the electrical contact after loading the spring to aid in removing the electrical contact from the housing. The upper jaws can extend at a right angle or any offset angle from the centerline of the pivot point and/or the lower jaws.

Embodiments will be described more fully hereinafter with reference to the accompanying drawings, which form a part hereof, and which show, by way of illustration, exemplary embodiments by which the systems and methods described herein may be practiced. The systems and methods may, however, be embodied in many different forms and should not be construed as limited to the embodiments set forth herein; rather, these embodiments are provided so that this disclosure will satisfy the statutory requirements and convey the scope of the subject matter to those skilled in the art.

What is claimed is:

1. A pair of pliers, comprising:
two plier legs;
two plier jaws, the upper jaws of the two plier jaws having a width less than the lower jaws of the of the two plier jaws; and
a hinge connecting the two plier legs.

2. The pair of pliers of claim 1, wherein the upper plier jaws tapered to a point.

3. The pair of pliers of claim 1, wherein the upper plier jaws having a width that is less than half the width of the lower plier jaws.

4. The pair of pliers of claim 1, wherein the upper plier jaws tapered to angle away from a centerline of the lower plier jaws.

5. The pair of pliers of claim 1, wherein the lower plier jaws has a rounded or beveled edge.

6. The pair of pliers of claim 1, further comprising a protective element that extends over at least a portion of the lower plier jaws.
